(19) United States
(12) Patent Application Publication
(10) Pub. No.: US 2009/0262007 A1
(43) Pub. Date: Oct. 22, 2009

(54) VEHICLE SPEED DETECTION DEVICE WITH WIRELESS COMMUNICATIONS CAPABILITY AND METHODS OF USE

(76) Inventor: James F. Kelly, Norcross, GA (US)

Correspondence Address: NIXON & VANDERHYE, PC, 901 NORTH GLEBE ROAD, 11TH FLOOR, ARLINGTON, VA, 22203, US

(21) Appl. No.: 12/106,544

(22) Filed: Apr. 21, 2008

(51) Int. Cl. G01S 13/58; G06Q 40/00; G01S 1/00

(52) U.S. Cl. 342/104; 342/357.06; 705/35

(57) ABSTRACT

A portable speed detecting device includes wireless communications capabilities. This allows the portable speed detecting device to obtain information from remote sources via a wireless link. It also facilitates the process of issuing and recording tickets. Further, it can provide an operator with the ability to accomplish a financial transaction so that a driver can pay an assessed fine.

### BACKGROUND

1. Field

The application discloses vehicle speed detection devices which are used by law enforcement agencies to enforce speed limit laws, and methods for their use.

2. Background

Law enforcement personnel currently use many different types of hand-held, portable vehicle speed detection devices to check the speed of moving vehicles. Such devices can make use or radar, laser and other sensing technologies to determine the speed of the vehicle.

During a typical speed law enforcement action, an Officer parks her or her vehicle on a side of a road, or perhaps on an overpass, and then uses a speed detection device to check the speed of passing vehicles. This may be done while the Officer is in the vehicle, or while the Officer is standing on the side of the road. When a vehicle is found to be exceeding the speed limit, the Officer either directs the driver to pull the speeding vehicle to the side of the road, or chases the vehicle and pulls it over. Then, the Officer usually writes a speeding ticket using a multi-copy, pre-printed form. The Officer gives one copy of the ticket to the driver of the speeding vehicle, and retains at least one copy for his records.

In some situations, the Officer may also use a computer located in his vehicle, or a radio, to request information about the vehicle, the driver, or possibly even a passenger in the vehicle. This information is usually requested from a central authority such as a law enforcement department or from a department of motor vehicles.

To request information about the driver, the Officer would usually have to provide the driver's name and/or license number to the central authority. The central authority could then provide such information as a history of prior violations, and whether there are any outstanding arrest warrants.

Likewise, to obtain information about the vehicle, the Officer would usually have to provide the central authority with vehicle identifying information such as the vehicle license or registration number. The central authority could then provide the Officer with information such as whether the vehicle's registration is current, the name of the owner, and whether the vehicle has been reported as stolen.

The Officer may then use the aforementioned information to decide whether additional actions are required. For instance, if the vehicle has been reported as stolen, or if there is an outstanding arrest warrant for the driver, the Officer would likely arrest the driver. If the vehicle's registration has expired, the Officer might write an additional ticket for this violation.

There are several disadvantages with the methods described above. When an Officer fills out a pre-printed ticket form, the Officer may enter incorrect information. Likewise, in virtually all instances, the information from the form will ultimately be copied into a central computer system, and the information may be incorrectly copied into the computer. This manual process can result in data errors, and it also requires that the same information be entered twice, once by the Officer by hand, and again when the information is input into the computer.

In addition, if an Officer pulls a car over for speeding, the Officer will have to return to his own vehicle to obtain information about the driver or the speeding vehicle through a vehicle-mounted computer or radio. This increases the duration of a traffic stop, and it also increases the amount of time that the Officer and the speeding vehicle are parked on the side of the road. Because vehicles on the side of the road can be hit by other passing vehicles, this increases the danger of the traffic stop for both the Officer and the driver of the speeding vehicle, as well as for any passengers in the speeding vehicle. It also simply increases the time that the Officer must spend to issue the ticket.

### BRIEF DESCRIPTION OF THE DRAWINGS

Embodiments will described with reference to the following drawing Figures, in which like reference numerals refer to like elements, and wherein:

FIG. 1 is a block diagram of a speed detection device with wireless communications capabilities;

FIG. 2 is a block diagram of elements of a system that makes use of a speed detection device as illustrated in FIG. 1; and

FIG. 3 is a flow diagram illustrating steps of a method of using a speed detection device as depicted in FIG. 1.

### DETAILED DESCRIPTION OF PREFERRED EMBODIMENTS

As mentioned above, known portable speed detecting devices used by law enforcement personnel typically make use of a laser emitter and an associated detector or a radar emitter and an associated detector to determine the speed of a moving vehicle. Such devices may also be capable of measuring a distance from the device to a target object. Such devices can also incorporate an inclination angle detector to determine an inclination angle to a target object, as well as an electronic compass to determine a bearing to the target object. Further, some such devices can also be equipped with a GPS receiver to obtain position data. Many of these devices allow the operator to record detected information in a memory within the device, or in an external memory device. In addition, many such devices can be coupled to a portable or desktop computer so that detected data can be downloaded into the computer. Known speed detector devices, however, do not typically include any sort of wireless communications capability.

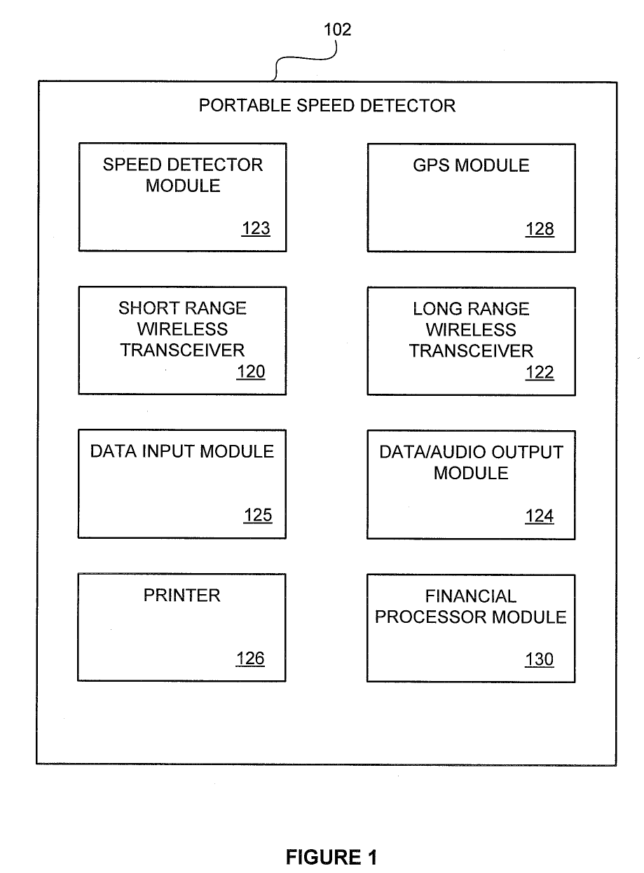

A block diagram of a speed detector which includes wireless communications capabilities is shown in FIG. 1. As shown therein, the portable speed detector 102 includes a speed detector module 123. The speed detector module can make use of any of the known technologies for detecting the speed of a moving vehicle, or any that are developed in the future. As noted above, the elements in this module may also be capable of determining a distance from the detecting device to a target object. Further, the speed detector module 123 might also include an inclination angle detector for detecting an inclination/declination angle from the device to a target object, at well as an electronic compass that detects an azimuth angle from the device to the target object. These features are generally known in the art.

The speed detector 102 may also include a short range wireless transceiver 120 which allows the speed detector to communicate with other similarly equipped devices that are located nearby. For instance, the short range wireless transceiver 120 could be a Bluetooth module which can be used to communicate with another Bluetooth enabled device. The short range wireless transceiver could also be a WiFi or WiMax module. Of course, these types of devices are only examples. Any type of known or later developed short range wireless communications devices could be used in a particular embodiment. Further, the portable speed detector could include multiple different types of short range wireless devices, or it could include multiple short range wireless devices which are all of the same basic type.

The speed detector could also include a long range wireless transceiver 122. The long range wireless transceiver 122 could be a cellular telephone module that is capable of communicating with a cell phone tower base station. Alternatively, the long range wireless transceiver 122 could be a radio transceiver capable of communicating over known radio frequencies, such as the VHF frequencies used by law enforcement personnel, UHF frequencies used by satellite transceivers, or any other type of radio frequency. Of course, any other type of known or later developed long range wireless communications device could also be used.

The portable speed detector may also include a data output module 124, which is capable of outputting data to an operator. The data output module 124 could include a display for displaying information to the operator. The display could be implemented using any one of a number of known display technologies, such as liquid crystal displays, plasma displays, organic electroluminescent displays and other known or future display technologies. Preferably, the display is a lightweight flat panel display that saves weight and space.

The data output module could also include a speaker or an audio output device for delivering audio output to the operator. For instance, instead of and/or in addition to a speaker, the audio output module could include an earpiece with a small speaker that is only audible to the operator. Such an earpiece could be connected to the portable speed detector with a wire, or with a wireless link, such as Bluetooth. A wireless link to an earpiece could also be supported by the portable speed detector's short range wireless transceiver 120.

The speed detector may further include a data input module 125. The data input module could utilize any number of different technologies to allow an operator to input data. This could include any number of different keypad designs. This could also include a touch-sensitive display screen, so that the data input module 125 is integrated with the display system, to thereby save additional weight and space.

In some embodiments, the speed detecting device may include various types of input/output ports to allow various devices to communicate with the speed detection device. For instance, the device could include one or more USB ports, or various types of standard and non-standard serial and parallel ports.

The data input module could also include a microphone which allows an operator to speak commands or to communicate with another person. The microphone could by connected to the speed detector with a wire, or it could be supported by the short range wireless transceiver 120 of the speed detector. Further, the microphone could be used in connection with voice recognition software running on a processor on-board the speed detector, or running on another processor that is linked to the speed detector via the short or long range wireless transceivers.

The data input module could be a separate device, such as an external keyboard or a separate PDA. These external devices could be coupled to the portable speed detector with a wire, or via the device's short range wireless communications module. For instance, the speed detector could be capable of linking to a separate PDA via a Bluetooth link, or to a separate portable laptop computer via a WiFi or WiMax link. This would allow the operator to input data using a keypad on the separate PDA or laptop computer.

Further, the data input module might include the ability to scan bar codes, read magnetically encoded data, read optically encoded data or read computer data storage devices. For instance, the data input module might be configured to read data from RFID devices, smart cards, credit cards, and computer data storage devices like magnetic and optical discs, memory sticks and the like. The data input module could be configured to allow an operator to download, input and/or scan data from any type of known or later developed data storage media.

The speed detector 102 may also include a printer 126. The printer could utilize any type of printing technology now known or which is later developed. Preferably the printer system would utilize a lightweight printing mechanism which prints onto conveniently stored media. For instance, the printer system could comprise a thermal printer that rapidly prints onto a roll of paper. Such printers are already in widespread use in portable devices that are designed to print receipts for consumer transactions such as credit card charges. The printer system 126 might also be configured to encode a data storage device with computer readable data so that the storage device can then be given to a customer.

The speed detector might also include a GPS module which is capable of determining the location of the speed detector. The GPS module may also include mapping software which allows the device to determine the location on a street at which the speed detector is located. For instance, in a highway environment, the GPS module could be capable of determining that the speed detector is located on the North bound side of Rt. 95, at mile marker 121.4. Alternatively, in an urban environment, the GPS module could be capable of determining that the speed detector is located in a city at the intersection of 21^{st} Street and 4^{th} Avenue.

The portable speed detector might also include a financial processor module.130. The financial processor module could be configured to initiate and/or complete financial transactions to charge a driver's credit or debit account, or to otherwise access funds available to the driver. For instance, the financial processor module 130 could work in connection with the data input module 125 to read a driver's credit or debit card, and then process a financial transaction with remote devices via a wireless link established over either a short or long range wireless transceiver. Likewise, the financial processor module could interact with some other type of electronic device possessed by the driver, such as a smart card or a cellular telephone to thereby process a financial transaction involving the movement of funds from one account to another. Of course, the financial processor module could also incorporate any other known or later developed method for processing a financial transaction. This would allow a driver to instantly pay a fine assessed for violation of a traffic regulation.

With the exception of the speed detector module 123, all of the elements described above are optional for any given embodiment of a portable speed detector. In addition, a particular embodiment of a portable speed detector could also include a variety of other elements and modules to add additional functionality to the device. Thus, the above description is not intended to be in any way limiting of the different modules and capabilities that might be added to a particular embodiment of a device.

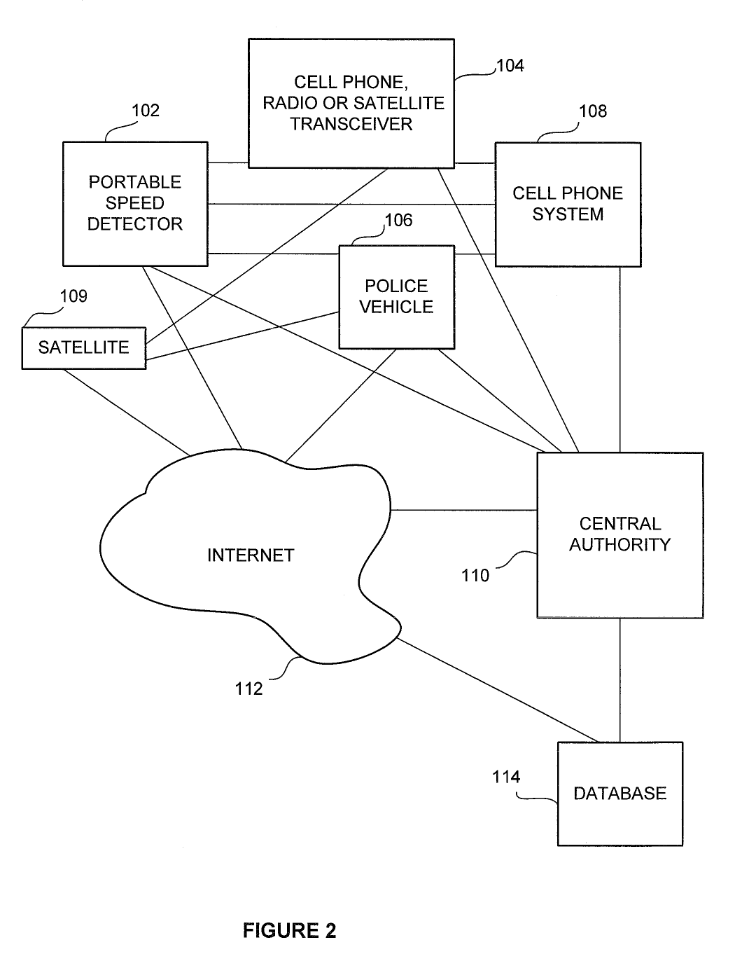

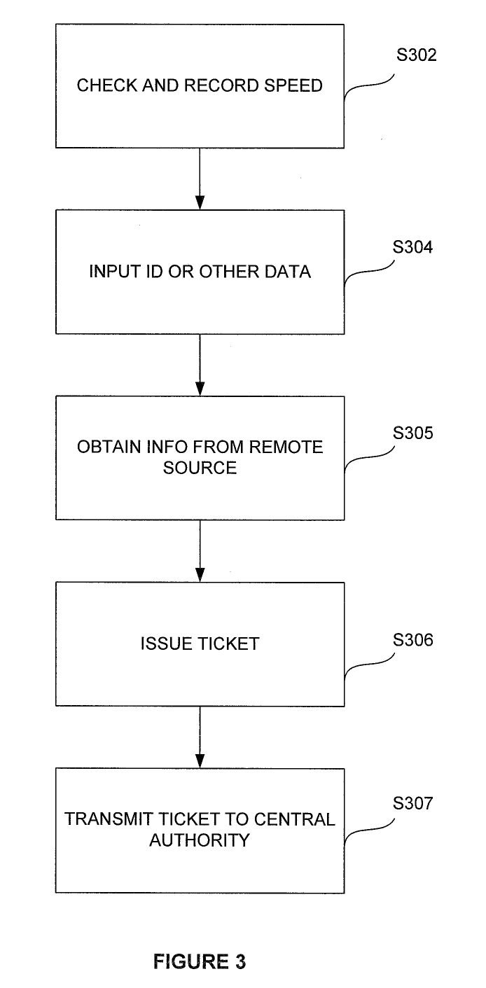

FIG. 2 is a block diagram illustrating how a portable speed detector with a wireless communications module could interface with other devices. This diagram will be used, in connection with the flow diagram of FIG. 3, to explain how law enforcement personnel could use a portable speed detector with wireless communications capability to carry out traffic law enforcement duties. This explanation will begin with an explanation of how the portable speed detector can communicate with external devices.

As illustrated in FIG. 2, the portable speed detector 102 could use a short range wireless transceiver to communicate with a corresponding device installed in a nearby police vehicle 106. The police vehicle 106 could itself be utilizing some other type of short or long range wireless communications device to communicate with a central authority 110, to access the Internet 112, or to communicate with some other remote source of information. For instance, the police vehicle could include a cellular telephone transceiver to access a central authority or the Internet via a cellular telephone network 108. Alternatively, the police vehicle might include a satellite transceiver that allows the police vehicle to communicate with a remote authority, the Internet or some other source of remote data via a satellite link 109. In still other situations, the police vehicle might be communicating with a central authority 110, the Internet 112 or some other source of remote data with a direct radio link. With any of these links, the portable speed detector could communicate with the central authority 110, the Internet 112 or with other sources of information, by relaying communications through the communications device(s) located in the police vehicle.

The portable speed detector 102 might also utilize a short range wireless transceiver to communicate with a nearby radio transceiver or cellular telephone or a satellite transceiver 104. Such a device could directly link to a central authority, the Internet or some other remote source of data, or the device could establish such a link via a satellite 109 or via a cellular telephone system 108. This would also allow the portable speed detector 102 to communicate with the central authority 110, the Internet or some other source of remote data by relaying communications through the cell phone, radio or satellite transceiver.

In still other embodiments, the portable speed detecting device 102 could utilize an internal long range wireless transceiver 122 to communicate directly with the central authority 110, the Internet 112 or some other source of data. Likewise, the internal long range wireless transceiver 112 in the portable speed detecting device could be used to communicate with the central authority 110, the Internet or some other remote source of data by establishing links to such sources via the cellular telephone network, a satellite or some other relay means.

Note also, the central authority 110 may be connected to a variety of external data sources such as an external database 114, the Internet 112, or other sources. This would allow the central authority to gather information from external sources, and then feed that data to the portable speed detector via one of the multiple different links described above and illustrated in FIG. 2.

The incorporation of either a short range wireless transceiver or a long range wireless transceiver into a portable speed detection device provides a law enforcement Officer, or any operator, with ability to send data to external systems, and to request and obtain data from external sources. As will be described below, this enables the operator to accomplish functions and perform law enforcement procedures which were not possible using prior art portable speed detectors that lacked a wireless communications capability. This capability can also serve to significantly reduce the amount of time it takes to accomplish certain functions, such as the generation of speeding tickets, and it can serve to reduce data errors. Further, entirely new functions can be performed that would have been impossible with prior art speed detectors lacking the wireless communications capability.

FIG. 3 illustrates steps of a method which can be performed with a portable speed detector as described above. At the beginning of the method, in step S302, the Officer would use the speed detecting module 123 to check and record a vehicle's speed. If the speed is above a posted limit, the Officer could then pull the vehicle to the side of the road to determine if the issuance of a speeding ticket or some other action is warranted.

In step S304, the Officer would obtain information about the driver and/or the vehicle, and this information would be input to the portable speed detector. As explained above, a data input module 125 of the portable speed detector 102 could be used to facilitate the input of the data. The Officer might be able to use an optical scanner in the portable speed detector to read a barcode on the vehicle that contains vehicle identification information. A barcode scanner in the portable speed detector could also be used to quickly and easily capture data encoded in a barcode on a vehicle registration card. Likewise, the driver's identifying information could be quickly and easily read from a barcode on a driver's license.

In other embodiments, a magnetic reader could be used to read information encoded in a magnetic strip of a vehicle registration card, a driver's license or some other type of personal ID card. In a similar manner, a RFID scanner in the portable speed detector could be used to quickly and easily read information from an RFID tag in a driver's license or other identification card, or from an RFID tag attached to the vehicle. These and other methods of quickly obtaining identifying information about a driver, a passenger or the vehicle itself will be readily apparent to those of ordinary skill in the art.

In step S305, the information gathered and input into the portable speed detector would then be used to pose a query for information that is sent to a central authority, or some other remote source of information. The central authority or remote source would obtain the requested information and relay it back to the portable speed detector. As explained above, the query and the reply message could take any one of a number of different communications paths, depending on how the portable speed detector is configured. The returned information could then be displayed on a display screen of the portable speed detector, or played in the form of audio information.

Based on the information received from the remote source, the Officer could decide what action to take. For instance, in step S306, the Officer could decide to issue a speeding ticket to the driver. The capabilities of the portable speed detector could be used to greatly automate the ticket issuance process. Assuming that all of the required information has already been captured in step S304, the printer in the portable speed detector could be used to quickly print a speeding ticket which could be handed to the driver. Note, the data input capabilities of the portable speed detector would have already resulted in the rapid input of the driver's information and the vehicle's information. Information about the location could have been captured by a GPS module 128 of the portable speed detector. Likewise, the actual speed of the vehicle and the time at which the speed was detected will have already been recorded. Thus, all of the information needed to issue the speeding ticket will already be available to the portable speed detector. By simply printing a speeding ticket, data entry errors that can occur when an Officer must hand write a ticket are eliminated.

Also, in step S307, the ticketing information could also be automatically relayed to a central computer system via one of the wireless links discussed above. This would eliminate the extra step of inputting the ticket data into a central computer system, which eliminates another source of potential error.

Of course, based on the information returned to the Officer in response to the query, the Officer might decide to take additional actions. For instance, the Officer might decide to issue an additional ticket for an expired driver's license or an expired vehicle registration. Here again, because all the relevant information about the driver and the vehicle is already loaded into the portable speed detector, such a ticket could be immediately printed and handed to the driver, and the ticket information could be relayed to a central computer system via one of the wireless links.

In addition, as noted above, the portable speed detector may be equipped with a financial processor module. The financial processor module would allow the Officer to immediately charge a driver's credit or debit account to satisfy a fine. Likewise, the Officer could use the portable speed detector to obtain payment from some other type of financial account, like a cell phone account. As explained above, the inclusion of the wireless communications capability will allow the portable speed detector to process a financial transaction via virtually any known or later developed payment system.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although a number of illustrative embodiments have been described, it should be understood that numerous other modifications and embodiments can be devised by those skilled in the art that will fall within the spirit and scope of the principles of this disclosure. More particularly, variations and modifications are possible in the component parts and/or arrangements of the combinations which would fall within the scope of the disclosure, the drawings and the appended claims. In addition to variations and modifications in the component parts and/or arrangements, alternative uses will also be apparent to those skilled in the art.

What is claimed is:

1. A speed detection device, comprising:
a speed detecting module that detects the speed of a moving object; and
a wireless communications module that allows the speed detection device to communicate with another wireless communications enabled device.

2. The speed detection device of claim 1, wherein the wireless communications module is a short range wireless transceiver.

3. The speed detection device of claim 1, wherein the wireless communications module is a long range wireless transceiver.

4. The speed detection device of claim 3, wherein the long range wireless transceiver comprises a cell phone module.

5. The speed detection device of claim 1, wherein the wireless communications module is configured to communicate with a remote source of data by relaying communications through another wireless communications enabled device.

6. The speed detection device of claim 1, further comprising a GPS module that is capable of determining a location of the speed detection device.

7. The speed detection device of claim 1, further comprising a data input module that allows an operator to input data into the device.

8. The speed detection device of claim 7, wherein the data input module comprises a keypad.

9. The speed detection device of claim 8, wherein the keypad is a touch sensitive display screen that also displays data to the operator.

10. The speed detection device of claim 7, wherein the data input module comprises a bar code scanner.

11. The speed detection device of claim 7, wherein the data input module comprises a magnetic reader capable of reading magnetically encoded data.

12. The speed detection device of claim 7, wherein the data input module comprises a device capable of reading data from computer data storage media.

13. The speed detection device of claim 1, further comprising a printer.

14. The speed detection device of claim 1, further comprising a financial processing module capable of processing a debit or credit transaction via the wireless communications module.

15. A method of using a speed detection device having a wireless communications module, comprising:
detecting a speed of a moving object using the speed detection device;
generating a query for data;
communicating the query to a remote data source via the wireless communications module;
receiving data from the remote data source in response to the query via the wireless communications module; and
presenting the received data to an operator using a data output module of the speed detection device.

16. The method of claim 15, wherein the generating step comprising inputting data into the speed detection device using a data input module of the speed detection device.

17. The method of claim 16, wherein the inputting step comprises reading data from a bar code with a bar code reader of the speed detection device.

18. The method of claim 16, wherein the inputting step comprises reading data encoded into an identification card.

19. The method of claim 15, further comprising printing a ticket using a printer of the speed detector, wherein the printing step uses information stored in the speed detection device.

20. The method of claim 15, further comprising processing a financial transaction with a financial transaction processing module of the speed detection device using data stored in the vehicle speed detection device.
